(19) United States
(12) Patent Application Publication
(10) Pub. No.: US 2019/0040307 A1
(43) Pub. Date: Feb. 7, 2019

(54) SHEAR-THINNING SELF-VISCOSIFYING SYSTEM FOR HYDRAULIC FRACTURING APPLICATIONS

(71) Applicant: Halliburton Energy Services, Inc., Houston, TX (US)

(72) Inventors: Eli Allen SCHNOOR, Kingwood, TX (US); Ali ALWATTARI, Kingwood, TX (US); Prashant CHOPADE, Kingwood, TX (US); Dipti SINGH, Kingwood, TX (US)

(21) Appl. No.: 16/073,900

(22) PCT Filed: May 10, 2016
(86) PCT No.: PCT/US2016/031654

§ 371 Date: Jul. 30, 2018

(51) Int. Cl. C09K 8/68; C09K 8/80; E21B 43/26

(52) U.S. Cl. CPC C09K 8/68; C09K 8/80; E21B 43/267; C09K 2208/26; E21B 43/26

(57) ABSTRACT

Methods of fracturing a subterranean formation are provided. An example method comprises introducing a treatment fluid into a wellbore penetrating a subterranean formation at a pressure sufficient to create or extend at least one fracture in the subterranean formation, wherein the treatment fluid comprises an aqueous base fluid and a hydrophobically-modified cellulose. Methods of preparing a treatment fluid are provided. An example method comprises adding solid hydrophobically-modified cellulose to an aqueous fluid comprising a total dissolved solids concentration of greater than 300,000 mg/L to produce hydrated hydrophobically-modified cellulose; and then adding at least a portion of the hydrated hydrophobically-modified cellulose to an aqueous base fluid to produce the treatment fluid.

### TECHNICAL FIELD

The present disclosure relates to treatment fluids for hydraulic fracturing operations and more particularly to the use of treatment fluids comprising hydrophobically-modified cellulose, referred to herein as “HMC,” in hydraulic fracturing operations of unconventional reservoirs.

### BACKGROUND

Unconventional reservoirs generally have low permeability and/or are brittle and may be easily damaged. Examples of unconventional reservoirs may include shale reservoirs, sandstone reservoirs, coal bed reservoirs, and the like. Because of their unique characteristics these reservoirs may be difficult to access and generally require some method of stimulation.

As with conventional reservoirs, high-viscosity crosslinked fluids have been used to treat unconventional reservoirs. The high-viscosity crosslinked fluids generally have large polymer loading values and sufficient amounts of crosslinker to increase the viscosity to the desired level. However, many of these high-viscosity crosslinked fluids proved too damaging, and consequently, a trend towards low-viscosity fluids has developed. The low-viscosity fluids utilize high pumping rates and have low polymer loading values. Typically the low-viscosity fluids use just enough polymer to provide sufficient friction reduction and do not use crosslinkers. These fluids are generally referred to as “slickwater” treatment fluids as they use just enough polymer to make the fluid a “slick.” Therefore, unlike the high-viscosity crosslinked fluids, the low-viscosity fluids do not utilize a crosslinked network, and consequently there is a reduced risk of formation damage and loss in proppant pack conductivity. Additionally, the larger volumes of water needed to provide the high pumping rates allows for more of the formation to be contacted by the treatment fluid, and this may result in more complex fracturing.

Although the low-viscosity fluids may be less damaging to unconventional reservoirs compared to their high-viscosity crosslinked counterparts, the low-viscosity fluids are also not as capable of transporting proppant compared to their high-viscosity crosslinked counterparts. Low-viscosity fluids generally rely on high pumping rates to provide sufficient proppant transport; however, the amount and size of proppant able to be transported may still be limited even with high pumping rates.

A treatment fluid referred to as a “waterfrac” was developed to improve proppant transport over the slickwater treatment fluids and yet still possess a relatively lower viscosity. The waterfrac treatment fluids may use the same polymers found in high-viscosity crosslinked fluids but without crosslinkers. This provides higher viscosity fluids through increased polymer concentration, but dramatically less viscosity than a crosslinked fluid. Even through waterfrac fluids can provide increased proppant concentration over slickwater fluids, their relatively low viscosity still lacks the transport capabilities of the crosslinked gels. For example, without the crosslinkers, the polymer loading may need to be increased to provide sufficient proppant transport capability. Increasing the polymer loading also increases the risk of formation damage. Additionally, some polymers used in the high-viscosity crosslinked fluids may not be suitable for the waterfrac treatments. For example, some polymers such as synthetic acrylamides may cause reservoir damage and may be difficult to break. Some polymers such as guar and guar derivatives may leave behind a residue on the formation that may reduce or totally impede flow. Some polymers such as carboxymethyl cellulose, which may break easily and cleanly, are ionic and therefore may not be salt-tolerant. These ionic polymers may lose viscosity in reservoirs with high-salt concentrations.

### BRIEF DESCRIPTION OF THE DRAWINGS

Illustrative examples of the present disclosure are described in detail below with reference to the attached drawing figures, which are incorporated by reference herein, and wherein:

FIG. 1 is an illustrative schematic of a system for delivering a treatment fluid to a downhole location;

FIG. 2 is a plot of the viscosity versus shear rate of an experimental treatment fluid sample and a comparative treatment fluid sample with varying salt concentrations;

FIG. 3 is a plot of the viscosity versus shear rate of an experimental treatment fluid sample and a comparative treatment fluid sample;

FIG. 4 is a plot of the friction reduction at various flow rates of an experimental treatment fluid sample and a comparative treatment fluid sample;

FIG. 5 is a plot of the viscosity versus shear rate of an experimental treatment fluid sample and a comparative treatment fluid sample before and after exposure to a gel breaker; and

FIG. 6 is a comparative photograph of an experimental treatment fluid sample and a guar sample after exposure to a gel breaker.

The illustrated figures are only exemplary and are not intended to assert or imply any limitation with regard to the environment, architecture, design, or process in which different examples may be implemented.

### DETAILED DESCRIPTION

The present disclosure relates to treatment fluids for hydraulic fracturing operations and more particularly to the use of treatment fluids comprising hydrophobically-modified cellulose, referred to herein as “HMC,” in hydraulic fracturing operations of unconventional reservoirs.

Disclosed examples comprise treatment fluids for hydraulic fracturing operations. The treatment fluids are aqueous-based and may comprise any type of aqueous base fluid. The treatment fluids further comprise an HMC. The cellulose may be modified with hydrophobic groups to increase the viscosity of the treatment fluid during periods of low shear; however, during periods of high shear, the hydrophobic/hydrophilic interactions of the HMC are easily broken, leading to a decrease in viscosity. The HMC is nonionic, and as such is more salt tolerant relative to ionic viscosifying additives such as carboxymethylcellulose. Additionally, using an HMC is advantageous because the HMC typically produces less insoluble residue upon breaking compared to other viscosifying additives such as guar and its derivatives. Therefore, the HMC described herein may impact formation permeability and hydrocarbon production to a lesser degree as compared to guar and its derivatives. The treatment fluids may optionally comprise a proppant and/or other additives. In a typical fracturing operation a pad fluid is introduced into a wellbore penetrating the subterranean formation at a pressure sufficient to create or extend at least one fracture in the subterranean formation and is followed by a proppant slurry so as to form a proppant pack in the at least one fracture with the proppant present in the proppant slurry. The treatment fluids described herein may be used as the pad fluid, the proppant slurry, or both.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present invention. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit.

Examples of the disclosed treatment fluids comprise HMC. The HMC comprises a graft polymer with a cellulose backbone covalently bonded to complementary hydrophobic groups. Without limitation by theory, the HMC may form entangled structures due to Van der Waals forces and hydrophilic/hydrophobic interactions. These weak intermolecular interactions may be easily broken during periods of high shear. However, during periods of low shear these weak intermolecular interactions form entangled structures that increase viscosity and may improve proppant suspension and transport. The cellulose may be modified by any suitable hydrophobic group.

The HMC may comprise a cellulose backbone of repeating cellulose units. The cellulose backbone may be linear or branched. The cellulose backbone may comprise any cellulose derivative capable of being grafted with the hydrophobic groups. Examples of cellulose derivatives include, but are not limited to hydroxyethyl cellulose, hydroxypropyl cellulose, methyl cellulose, hydroxypropyl methyl cellulose, ethyl hydroxyethyl cellulose, methyl hydroxyethyl cellulose, or combinations thereof. The cellulose backbone may comprise a chain of about 1000 cellulose repeating units to about 2,000,000 cellulose repeating units. In preferred examples, the cellulose backbone may comprise a chain of about 1000 cellulose repeating units to about 1,500,000 cellulose repeating units. As another example, the cellulose backbone may comprise a chain of about 1000 cellulose repeating units to about 1,200,000 cellulose repeating units. The chain length of the cellulose backbone may range from any lower limit to any upper limit and encompass any subset between the upper and lower limits. Some of the lower limits listed above may be greater than some of the listed upper limits. One skilled in the art will recognize that the selected subset will require the selection of an upper limit in excess of the selected lower limit. Therefore, it is to be understood that every range of values is encompassed within the broader range of values. For example, the chain length of the cellulose backbone may be about 300,000 cellulose repeating units, about 500,000 cellulose repeating units, about 700,000 cellulose repeating units, about 1,000,000 cellulose repeating units, about 1,500,000 cellulose repeating units.

The HMC is a graft polymer which may comprise any hydrophobic groups sufficient for use in the treatment fluids. Examples of hydrophobic groups may include, but are not limited to, saturated aliphatics comprising between 8 and 30 carbons, saturated alcohols comprising between 1 and 30 carbons, or any combination thereof. The HMC comprises a sufficient degree of hydrophobicity to provide the treatment fluid the desired viscosity under low shear.

Optionally, the HMC may be partially functionalized with a degree of substitution less than 0.3 to have a methyl ester, carboxylate, sulfonate, sulfate, amine, or a combination thereof.

The HMC may have a molecular weight between about 100,000 g/mol to about 2,000,000 g/mol. In preferred examples, the molecular weight of the HMC may be from about 500,000 g/mol to about 1,500,000 g/mol. As another example, the molecular weight of the HMC may be from about 700,000 g/mol to about 1,200,000 g/mol. The molecular weight of the HMC may range from any lower limit to any upper limit and encompass any subset between the upper and lower limits. Some of the lower limits listed above may be greater than some of the listed upper limits. One skilled in the art will recognize that the selected subset will require the selection of an upper limit in excess of the selected lower limit. Therefore, it is to be understood that every range of values is encompassed within the broader range of values. For example, the molecular weight of the HMC may be about 100,000 g/mol, about 500,000 g/mol, about 1,000,000 g/mol, about 1,500,000 g/mol, about 2,000,000 g/mol. With the benefit of this disclosure one of ordinary skill in the art will be readily able to select a species of HMC for use in the disclosed treatment fluids.

The HMC may be present in the treatment fluid in any sufficient concentration. For example, the HMC may be present in the treatment fluid in a concentration of about 1 lbm/1000 gal to about 80 lbm/1000 gal. In preferred examples the concentration of the HMC may be from about 1 lbm/1000 gal to about 100 lbm/1000 gal. As another example, the concentration of the HMC may be from about 5 lbm/1000 gal to about 60 lbm/1000 gal. The concentration of the HMC may range from any lower limit to any upper limit and encompass any subset between the upper and lower limits. Some of the lower limits listed above may be greater than some of the listed upper limits. One skilled in the art will recognize that the selected subset will require the selection of an upper limit in excess of the selected lower limit. Therefore, it is to be understood that every range of values is encompassed within the broader range of values. For example, the concentration of the HMC may be about 1 lbm/1000 gal, about 5 lbm/1000 gal, about 10 lbm/1000 gal, about 25 lbm/1000 gal, about 60 lbm/1000 gal. With the benefit of this disclosure one of ordinary skill in the art will be readily able to select a concentration of HMC for use in the disclosed treatment fluids.

As discussed above, the HMC is nonionic. As used herein, “nonionic” refers to a molecule that is not charged and does not disassociate into ions in an aqueous solution. As illustrated below, treatment fluids comprising the nonionic HMC may experience smaller decreases in viscosity relative to treatment fluids comprising analogous ionic viscosifying additives. Additionally, because the HMC is nonionic, the HMC may be hydrated in aqueous base fluids comprising high levels of salt. Analogous ionic viscosifying additives such as carboxymethylcellulose are hydrated in freshwater before they are added to aqueous base fluids containing salts. Because of this characteristic, the HMC may be hydrated in aqueous fluids with high salt concentrations (e.g., seawater, produced water, etc.) prior to addition to the aqueous base fluid. Moreover, as the HMC may be hydrated in brines and fluids comprising total dissolved solids concentrations greater than 50,000 mg/L, in some examples, the hydrated HMC may be used directly in the aqueous base fluid it was hydrated in and does not require addition to an additional aqueous base fluid comprising a different level of total dissolved solids than the aqueous base fluid used to hydrate the HMC. Alternatively, methods of preparing the treatment fluids disclosed herein may comprise hydrating the HMC in saltwater, seawater, brine, or produced water and then adding the hydrated HMC to the aqueous base fluid of an example treatment fluid. For example, the disclosed methods may comprise adding solid HMC to an aqueous fluid comprising a total dissolved solids concentration of at least 50,000 mg/L to hydrate the HMC. For example, the disclosed methods may comprise adding solid HMC to an aqueous fluid comprising a total dissolved solids concentration of at least 100,000 mg/L to hydrate the HMC. In preferred examples the disclosed methods may comprise adding solid HMC to an aqueous fluid comprising a total dissolved solids concentration of at least 200,000 mg/L to hydrate the HMC. As another example, the disclosed methods may comprise adding solid HMC to an aqueous fluid comprising a total dissolved solids concentration of at least 300,000 mg/L to hydrate the HMC. The total dissolved solids comprise monovalent, divalent, and trivalent ions. The methods may further comprise removing at least a portion of the hydrated HMC and adding said portion to an aqueous base fluid. As discussed above, this further addition step may be unnecessary as the HMC is able to hydrate in aqueous base fluids comprising large amounts of dissolved solids. Without limitation by theory, the order of addition, dwell time, and osmotic pressure may be decisive factors in whether a polymer dissolves at all, dissolves too slowly, or clumps and has reduced functionality. Because of the unique characteristics discussed above, the HMC may be added to directly to the base fluid, including saltwater, or the base fluid may be added directly to the HMC prior to introduction to the wellbore. The HMC may be hydrated under any order of addition in its preparation. Further, the HMC may be hydrated by stepwise or continuous additions of the HMC to the base fluid, or alternatively, by stepwise or continuous additions of the base fluid to the HMC.

The treatment fluids comprise an aqueous base fluid. The aqueous base fluid may be any aqueous fluid compatible with the HMC and any of the other components of the treatment fluid. Aqueous base fluids suitable for use in the treatment fluids described herein may comprise freshwater, saltwater (e.g., water containing one or more salts dissolved therein), brine (e.g., saturated salt water), seawater, produced water, or combinations thereof. Generally, the water may be from any source provided that it does not contain components that might adversely affect the stability and/or performance of the treatment fluid. In certain examples, the density of the aqueous base fluid can be adjusted, among other purposes, to provide additional proppant transport and suspension in the treatment fluids used in the methods described herein. In certain examples, the pH of the aqueous base fluid may be adjusted (e.g., by a buffer or other pH adjusting agent), among other purposes, to reduce the viscosity of the treatment fluid (e.g., activate a gel breaker, etc.). In these examples, the pH may be adjusted to a specific level, which may depend on, among other factors, the types of additives included in the treatment fluid. One of ordinary skill in the art, with the benefit of this disclosure, will recognize when such density and/or pH adjustments are appropriate. In some examples, the pH range may preferably be from about 7 to about 13. With the benefit of this disclosure, one of ordinary skill in the art will be readily able to select an aqueous base fluid for use in the disclosed treatment fluids.

The treatment fluids may optionally comprise proppant. It is to be understood the proppant may comprise any known shapes of materials, including substantially spherical materials, fibrous materials, polygonal materials (such as cubic materials), and combinations thereof. Examples of proppant suitable for use in treatment fluids may include, but are not limited to, sand, bauxite, ceramic materials, glass materials, polymer materials, polytetrafluoroethylene materials, nut shell pieces, cured resinous particulates comprising nut shell pieces, seed shell pieces, cured resinous particulates comprising seed shell pieces, fruit pit pieces, cured resinous particulates comprising fruit pit pieces, wood, composite particulates, and combinations thereof. Suitable composite particulates may comprise a binder and a filler material wherein suitable filler materials include silica, alumina, fumed carbon, carbon black, graphite, mica, titanium dioxide, meta-silicate, calcium silicate, kaolin, talc, zirconia, boron, fly ash, hollow glass microspheres, solid glass, or combinations thereof. The mean particulate size of the proppant may range from about 2 mesh to about 400 mesh or less on the U.S. Sieve Series; however, in certain circumstances, other sizes or mixtures of sizes may be desired and will be entirely suitable for practice of the examples described herein. In particular examples, preferred mean particulates size distribution ranges are one or more of 6/12, 8/16, 12/20, 16/30, 20/40, 30/50, 40/60, 40/70, or 50/70 mesh. With the benefit of this disclosure, one of ordinary skill in the art will be readily able to select a type and size of proppant for use in the disclosed treatment fluids.

In some examples, the proppant may be present in the treatment fluids in an amount ranging from about 0.5 pounds per gallon (“ppg”) to about 30 ppg. In preferred examples, the proppant may be present in the treatment fluid in an amount of about 1 ppg to about 20 ppg. As another example, the proppant may be present in the treatment fluid in an amount of about 5 ppg to about 10 ppg. The concentration of the proppant may range from any lower limit to any upper limit and encompass any subset between the upper and lower limits. Some of the lower limits listed above may be greater than some of the listed upper limits. One skilled in the art will recognize that the selected subset will require the selection of an upper limit in excess of the selected lower limit. Therefore, it is to be understood that every range of values is encompassed within the broader range of values. For example, the concentration of the proppant may be about 0.5 ppg, about 1 ppg, about 2.5 ppg, about 5 ppg, about 7.5 ppg, about 10 ppg, about 15 ppg, about 20 ppg, about 25 ppg, or about 30 ppg. With the benefit of this disclosure, one of ordinary skill in the art will be readily able to select a concentration of proppant for use in the disclosed treatment fluids.

The treatment fluids may optionally comprise delayed gel breakers such as enzyme, oxidizing, acid buffer, or temperature-activated gel breakers. The gel breakers may be used to reduce the viscosity of the treatment fluids at times of low shear or in the absence of shear. Examples of gel breakers may include, but are not limited to, persulfates, such as ammonium, sodium, potassium persulfate, etc.; chlorates, such as sodium chlorate, potassium chlorate, etc.; chlorites, such as sodium chlorite, etc.; hypochlorites, such as sodium, lithium, calcium hypochlorite, etc.; bromates; perborates, such as sodium perborate, etc.; permanganates; chlorinated lime; potassium perphosphate; iodates; magnesium monoperoxyphthalate hexahydrate; organic chlorine derivatives, such as N,N′-dichlorodimethylhydantoin, N-chlorocyanuric acid, etc.; peroxides, such as hydrogen peroxide, sodium peroxide, calcium peroxide, zinc peroxide, carbamide peroxide, urea peroxide, etc.; percarbonates, such as sodium percarbonate, potassium percarbonate, ammonium percarbonate, etc.; salts thereof derivatives thereof; or combinations thereof.

In some examples, the gel breaker may be present in the treatment fluids in an amount ranging from about 0.001% by weight of the HMC to about 10% by weight of the HMC. In preferred examples, the gel breaker may be present in the treatment fluid in an amount of about 0.01% by weight of the HMC to about 1% by weight of the HMC. As another example, the gel breaker may be present in the treatment fluid in an amount of about 0.1% by weight of the HMC to about 0.5% by weight of the HMC. The concentration of the gel breaker may range from any lower limit to any upper limit and encompass any subset between the upper and lower limits. Some of the lower limits listed above may be greater than some of the listed upper limits. One skilled in the art will recognize that the selected subset will require the selection of an upper limit in excess of the selected lower limit. Therefore, it is to be understood that every range of values is encompassed within the broader range of values. For example, the concentration of the gel breaker may be about 0.001% by weight of the HMC, 0.01% by weight of the HMC, 0.1% by weight of the HMC, 0.5% by weight of the HMC, 1% by weight of the HMC, 2% by weight of the HMC, 3% by weight of the HMC, 4% by weight of the HMC, 5% by weight of the HMC, or 10% by weight of the HMC. With the benefit of this disclosure, one of ordinary skill in the art will be readily able to select a species and concentration of gel breaker for use in the disclosed treatment fluids.

The treatment fluids may optionally comprise additional additives. Examples of these additional additives may include, but are not to be limited to, salts, fluid loss control agents, emulsifiers, dispersion aids, corrosion inhibitors, foaming agents, gases, pH control additives, biocides, stabilizers, chelating agents, scale inhibitors, gas hydrate inhibitors, oxidizers, reducers, friction reducers, clay stabilizing agents, the like, or any combination thereof. With the benefit of this disclosure, one of ordinary skill in the art will be readily able to select the additives required to achieve a desired result in practicing the methods disclosed herein.

In some examples the treatment fluids do not comprise crosslinking agents. It is to be understood that in examples where it is stated that the treatment fluids do not comprise crosslinking agents, these example treatment fluids are not prepared with crosslinking agents, and crosslinking agents are not present in these example treatment fluids when introduced into the wellbore. Once introduced into the wellbore the treatment fluids may encounter crosslinking agents already present in the wellbore. As used herein, “crosslinking agents” form substantially permanent crosslinks between the same or different polymer molecules. General examples of crosslinking agents are metal ions. Examples of such crosslinking agents include, but are not limited to, zirconium compounds (e.g., zirconium lactate, zirconium lactate triethanolamine, zirconium carbonate, zirconium acetylacetonate, zirconium maleate, zirconium citrate, zirconium oxychloride, and zirconium dlisopropylamine lactate); titanium compounds (e.g., titanium lactate, titanium maleate, titanium citrate, titanium ammonium lactate, titanium triethanolamine, and titanium acetylacetonate); aluminum compounds e.g., aluminum acetate, aluminum lactate, or aluminum citrate); antimony compounds; chromium compounds; iron compounds (e.g., iron chloride); copper compounds; zinc compounds; sodium aluminate; and combinations thereof.

In some examples the treatment fluids do not comprise surfactants. It is to be understood that in examples where it is stated that the treatment fluids do not comprise surfactants, these example treatment fluids are not prepared with surfactants, and that surfactants are not present in these example treatment fluids when introduced into the wellbore. Once introduced into the wellbore the treatment fluids may encounter surfactants already present in the wellbore. As used herein, “surfactants” are compounds that lower the surface tension of a liquid, the interfacial tension between two liquids, or between a liquid and a solid, or between a liquid and a gas. Surfactants may act as detergents, wetting agents, emulsifiers, foaming agents, and dispersants. General examples of surfactants are cationic surfactants, anionic surfactants, and non-ionic surfactants. Examples of such cationic surfactants include, but are not limited to, alkyl amines, alkyl amine salts, quaternary ammonium salts such as trimethyltallowammonium chloride, amine oxides, alkyltrimethyl amines, triethyl amines, alkyldimethylbenzylamines, alkylamidobetaines such as cocoamidopropyl betaine, alpha-olefin sulfonate, C8 to C22 alkylethoxylate sulfate, trimethylcocoammonium chloride, derivatives thereof, or combinations thereof. Examples of such anionic surfactants include, but are not limited to, alkyl carboxylates, alkylether carboxylates, N-acylaminoacids, N-acylglutamates, N-acylpolypeptides, alkylbenzenesulfonates, paraffinic sulfonates, a-olefinsulfonates, lignosulfates, derivatives of sulfosuccinates, polynapthylmethylsulfonates, alkyl sulfates, alkylethersulfates, mono alkylphosphates, polyalkylphosphates, fatty acids, alkali salts of acids, alkali salts of fatty acids, alkaline salts of acids, sodium salts of acids, sodium salts of fatty acid, alkyl ethoxylate, soaps, derivatives thereof, and combinations thereof. Examples of such nonionic surfactants include, but are not limited to, alcohol oxylalkylates, alkyl phenol oxylalkylates, nonionic esters such as sorbitan esters alkoxylates of sorbitan esters, castor oil alkoxylates, fatty acid alkoxylates, lauryl alcohol alkoxylates, nonylphenol alkoxylates, octylphenol alkoxylates, and tridecyl alcohol alkoxylates.

The example treatment fluids may be used in hydraulic fracturing operations. For example, the treatment fluids may be used as the pad fluid that is introduced into the subterranean formation at a pressure above the fracture gradient of the formation so as to create or extend at least one fracture therein. In another example, the treatment fluids may comprise proppant and may be used to transport proppant downhole (e.g., for forming proppant packs). The viscosity increase provided by the HMC may aid in suspending the proppant and may allow for higher concentration of proppant and/or different classes of proppant to be included in the treatment fluids relative to analogous treatment fluids which do not comprise HMC. The example treatment fluids may be used to hydraulically fracture reservoirs that have low permeability. Examples of these reservoirs include, but are not limited to, shale reservoirs, sandstone reservoirs, and coal bed reservoirs. The example treatment fluids may be used in both slickwater and waterfrac applications as described. Further, although use in hydraulic fracturing operations is described, it is to be understood that the HMC may be used in any application of a stimulation fluid. Additionally, since the HMC may be used as general rheology modifier, the HMC may also be used in applications using rheology modifiers. For example, the HMC may my used in drilling fluids, displacement fluids, completion fluids, etc.

In various examples systems configured for delivering the treatment fluids described herein to a downhole location are described. In various examples the systems can comprise a pump fluidly coupled to a tubular, the tubular containing a treatment fluid comprising HMC, and an aqueous base fluid.

The pump may be a high pressure pump in some examples. As used herein, the term “high pressure pump” will refer to a pump that is capable of delivering a fluid downhole at a pressure of about 1000 psi or greater. A high pressure pump may be used when it is desired to introduce the treatment fluid to a subterranean formation at or above a fracture gradient of the subterranean formation, but it may also be used in cases where fracturing is not desired. In some examples the high pressure pump may be capable of fluidly conveying particulate matter, such as proppant, into the subterranean formation. Suitable high pressure pumps will be known to one having ordinary skill in the art and may include, but are not limited to, floating piston pumps and positive displacement pumps.

In other examples the pump may be a low pressure pump. As used herein, the term “low pressure pump” will refer to a pump that operates at a pressure of about 1000 psi or less. In some examples a low pressure pump may be fluidly coupled to a high pressure pump that is fluidly coupled to the tubular. That is, in such examples the low pressure pump may be configured to convey the treatment fluid to the high pressure pump. In such examples the low pressure pump may “step up” the pressure of the treatment fluid before it reaches the high pressure pump.

In some examples the systems described herein can further comprise a mixing tank that is upstream of the pump and in which the treatment fluid is formulated. In various examples the pump (e.g., a low pressure pump, a high pressure pump, or a combination thereof) may convey the treatment fluid from the mixing tank or other source of the treatment fluid to the tubular. In other examples, however, the treatment fluid can be formulated offsite and transported to a worksite, in which case the treatment fluid may be introduced to the tubular via the pump directly from its shipping container (e.g., a truck, a railcar, a barge, or the like) or from a transport pipeline. In either case the treatment fluid may be drawn into the pump, elevated to an appropriate pressure, and then introduced into the tubular for delivery downhole.

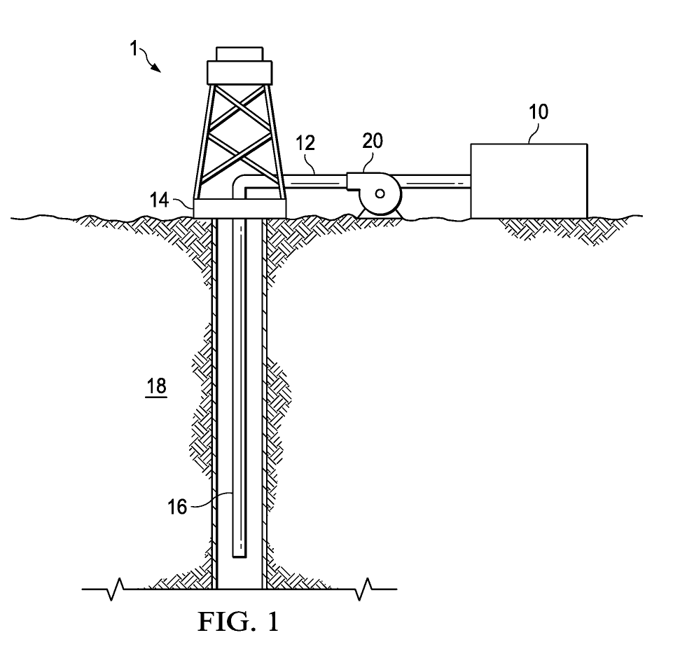

FIG. 1 shows an illustrative schematic of a system that can deliver treatment fluids of the present invention to a downhole location, according to one or more examples. It should be noted that while FIG. 1 generally depicts a land-based system, it is to be recognized that like systems may be operated in subsea locations as well. As depicted in FIG. 1, system 1 may include mixing tank 10, in which a treatment fluid may be formulated. The treatment fluid may be conveyed via line 12 to wellhead 14, where the treatment fluid enters tubular 16, tubular 16 extending from wellhead 14 into subterranean formation 18. Upon being ejected from tubular 16, the treatment fluid may subsequently penetrate into subterranean formation 18. Pump 20 may be configured to raise the pressure of the treatment fluid to a desired degree before its introduction into tubular 16. It is to be recognized that system 1 is merely exemplary in nature, and various additional components may be present that have not necessarily been depicted in FIG. 1 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 1, the treatment fluid may, in some examples, flow back to wellhead 14 and exit subterranean formation 18. In some examples the treatment fluid that has flowed back to wellhead 14 may subsequently be recovered and recirculated to subterranean formation 18.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 1.

### EXAMPLES

The present disclosure can be better understood by reference to the following examples which are offered by way of illustration. The present disclosure is not limited to the examples given herein.

### Example 1

An experiment sample of the treatment fluid was prepared. 1.8 g of HMC was hydrated in 250 mL of tap water for 30 minutes. Another sample of the same HMC was hydrated in 250 mL of 7% KCl (7% v/m KCl=70,000 ppm=70,000 mg/L) for 30 minutes. A third sample of the same HMC was hydrated in 250 mL of 10% NaCl (10% v/m NaCl=100,000 ppm=100,000 mg/L) for 30 minutes.

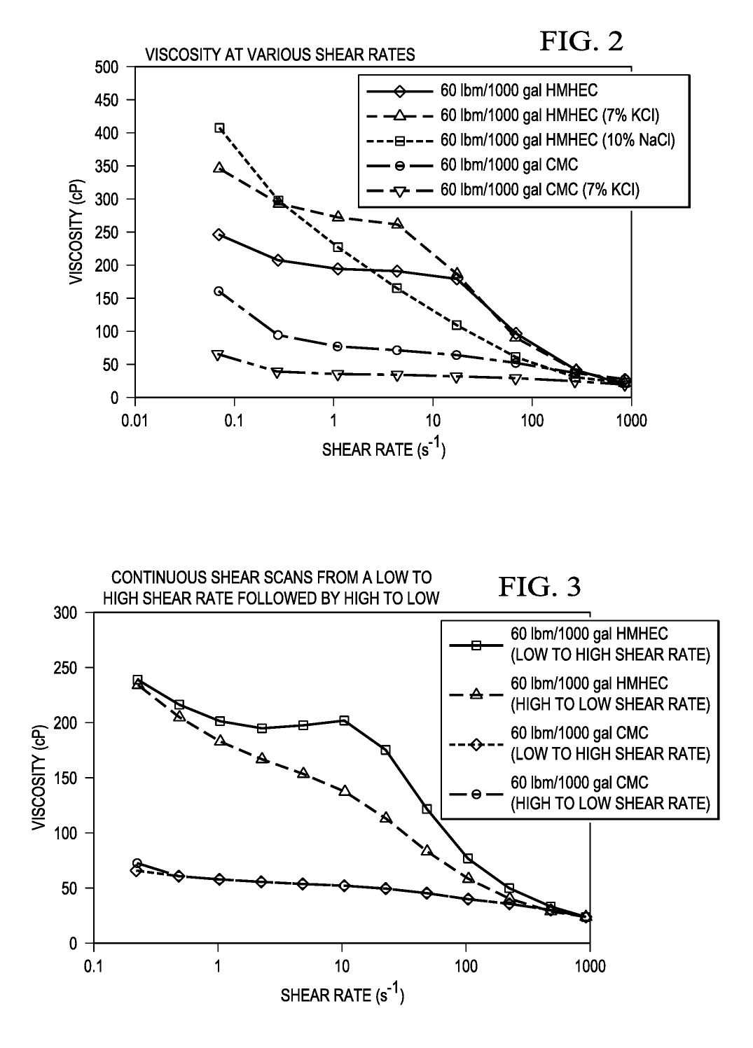

A comparative sample of the treatment fluid was prepared. 1.8 g of carboxymethylcellulose (referred to herein as “CMC”) was hydrated in 250 mL of tap water for 30 minutes. A second sample of the CMC was hydrated in 7% KCl for 30 minutes. The experimental and comparative samples were loaded into an Ares G2 rheometer equipped with a cup and din bob geometry. Rheology data is illustrated in FIG. 2.

This example illustrates that the HMC provides additional low end viscosity even in the presence of high salt concentrations.

### Example 2

An experiment sample of the treatment fluid was prepared. 1.8 g of HMC was hydrated in 250 mL of tap water for 30 minutes. A comparative sample of the treatment fluid was prepared. 1.8 g of CMC was hydrated in 250 mL of tap water for 30 minutes. The experimental and comparative samples were loaded into an Ares G2 rheometer equipped with a cup and din bob geometry, and the viscosity versus shear rate was measured at a temperature of 75° F. The shear rate was scanned from low to high and then followed by high to low. A plot of the rheology data is illustrated in FIG. 3. This example illustrates that the HMC provides additional viscosity as the shear rate decreases while providing low viscosity at higher rates.

### Example 3

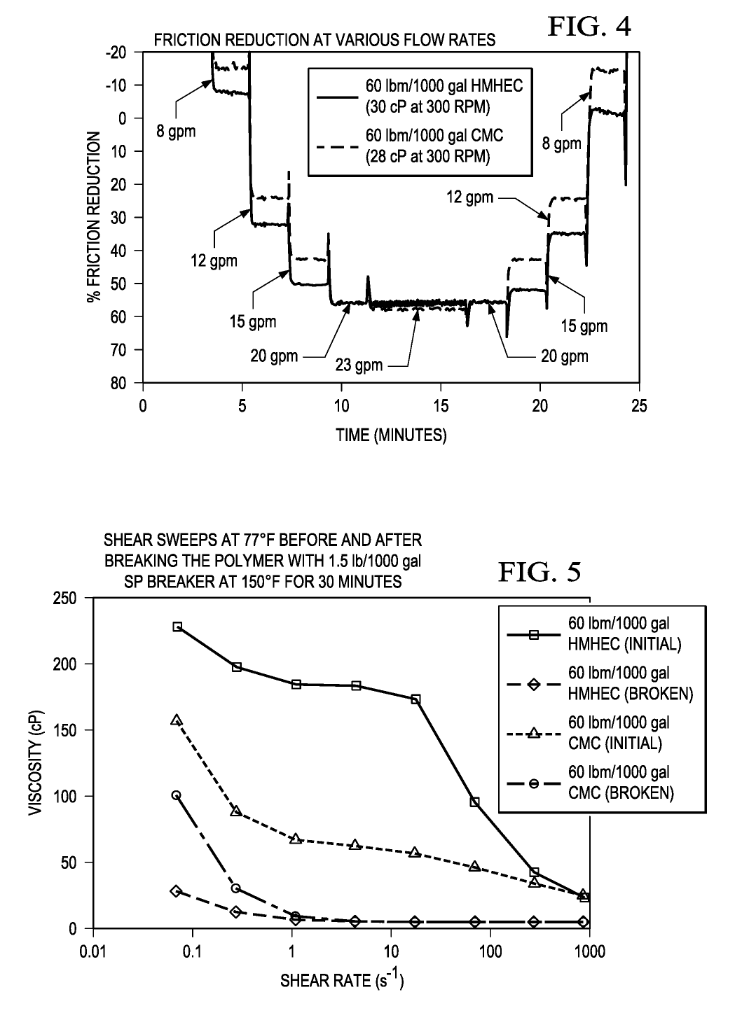

An experimental sample of the treatment fluid was prepared. 144 g of HMC was hydrated in 20 L of tap water for 30 minutes. A comparative sample of the treatment fluid was prepared by hydrating 144 g of CMC in 20 L of tap water for 30 minutes. The experimental and comparative samples were loaded into a friction loop. The pressure drop was measure at various flow rates and converted into friction reduction compared to tap water. A plot of the friction reduction data is illustrated in FIG. 4.

This example illustrates that the HMC provides better or equal friction reduction compared to the CMC polymer.

### Example 4

1.5 lbm/1000 gal of sodium persulfate gel breaker was added to the experimental and comparative samples of EXAMPLE 2 and the samples were loaded into an Ares G2 rheometer equipped with a cup and din bob geometry. The viscosity versus shear rate was measured at a temperature of 75° F. The sample was then heated to 150° F. for 30 minutes in the rheometer. The sample temperature was then returned to 75° F. and the shear scan was repeated. A plot of the data is illustrated in FIG. 5.

This example illustrates that the HMC breaks easily with the gel breaker in a short period of time at relatively low temperatures.

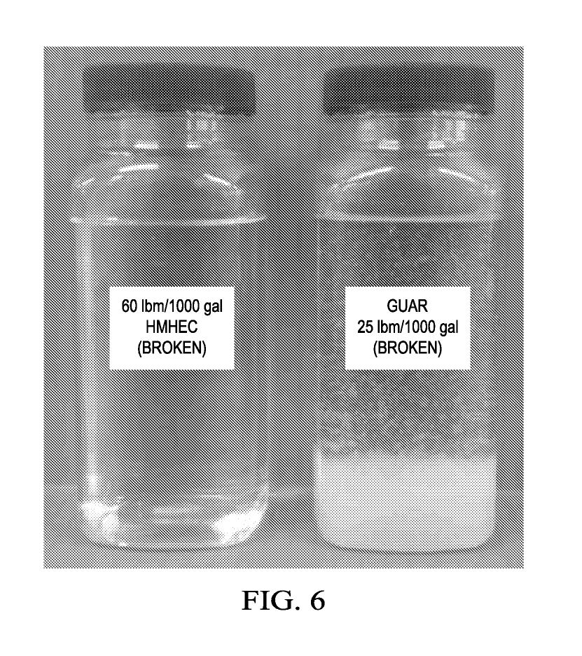

Additionally, FIG. 6 is a photograph of a comparative example of a broken HMC, specifically a hydrophobically-modified hydroxyethyl cellulose, juxtaposed with a broken sample of guar. The photograph illustrates that a broken HMC may not produce visual signs of insoluble residue or precipitate as may be seen in other types of viscosifying additives. As such, it may be expected that the HMC described herein may impact formation permeability and hydrocarbon production to a lesser degree as compared to other types of viscosifying additives such as guar and its derivatives.

Methods of fracturing a subterranean formation are provided. An example method comprises introducing a treatment fluid into a wellbore penetrating a subterranean formation at a pressure sufficient to create or extend at least one fracture in the subterranean formation, wherein the treatment fluid comprises an aqueous base fluid and a hydrophobically-modified cellulose. The hydrophobically-modified cellulose may comprise a hydrophobic group selected from the group consisting of saturated aliphatics comprising between 8 and 30 carbons, saturated alcohols comprising between 1 and 30 carbons, and combinations thereof. The backbone of the hydrophobically-modified cellulose may comprise a chain of about 1000 cellulose repeating units to about 2,000,000 cellulose repeating units. The hydrophobically-modified cellulose may have a molecular weight between about 100,000 g/mol to about 2,000,000 g/mol. The hydrophobically-modified cellulose may be present in the treatment fluid in a concentration of about 1 lbm/1000 gal to about 80 lbm/1000 gal. The treatment fluid may further comprise a plurality of proppant particles, and wherein the method further comprises forming a proppant pack in at least one fracture extending from the wellbore into the subterranean formation. The treatment fluid may further comprise a gel breaker. The hydrophobically-modified cellulose may be nonionic. The aqueous base fluid may be selected from the group consisting of freshwater, saltwater, brine, seawater, produced water, and combinations thereof. The treatment fluid may not comprise a crosslinking agent. The treatment fluid may not comprise a surfactant.

Methods of preparing a treatment fluid are provided. An example method comprises adding solid hydrophobically-modified cellulose to an aqueous fluid comprising a total dissolved solids concentration of greater than 300,000 mg/L to produce hydrated hydrophobically-modified cellulose; and then adding at least a portion of the hydrated hydrophobically-modified cellulose to an aqueous base fluid to produce the treatment fluid. The hydrophobically-modified cellulose may comprise a hydrophobic group selected from the group consisting of saturated aliphatics comprising between 8 and 30 carbons, saturated alcohols comprising between 1 and 30 carbons, and combinations thereof. The backbone of the hydrophobically-modified cellulose may comprise a chain of about 1000 cellulose repeating units to about 2,000,000 cellulose repeating units. The hydrophobically-modified cellulose may have a molecular weight between about 100,000 g/mol to about 2,000,000 g/mol. The hydrophobically-modified cellulose may be present in the treatment fluid in a concentration of about 1 lbm/1000 gal to about 80 lbm/1000 gal. The treatment fluid may further comprise a plurality of proppant particles, and wherein the method further comprises forming a proppant pack in at least one fracture extending from the wellbore into the subterranean formation. The treatment fluid may further comprise a gel breaker. The hydrophobically-modified cellulose may be nonionic. The aqueous base fluid may be selected from the group consisting of freshwater, saltwater, brine, seawater, produced water, and combinations thereof. The treatment fluid may not comprise a crosslinking agent. The treatment fluid may not comprise a surfactant.

A system for delivering a treatment fluid to a subterranean formation is provided. An example system comprises a treatment fluid comprising a hydrophobically-modified cellulose, and an aqueous base fluid; a tubular penetrating the subterranean formation; and a pump coupled to the tubular, wherein the pump is configured to pump the treatment fluid through the tubular and into the subterranean formation. The tubular may extend from a wellhead and is fluidly coupled to a mixing tank upstream of the wellhead with a line. The hydrophobically-modified cellulose may comprise a hydrophobic group selected from the group consisting of saturated aliphatics comprising between 8 and 30 carbons, saturated alcohols comprising between 1 and 30 carbons, and combinations thereof. The backbone of the hydrophobically-modified cellulose may comprise a chain of about 1000 cellulose repeating units to about 2,000,000 cellulose repeating units. The hydrophobically-modified cellulose may have a molecular weight between about 100,000 g/mol to about 2,000,000 g/mol. The hydrophobically-modified cellulose may be present in the treatment fluid in a concentration of about 1 lbm/1000 gal to about 80 lbm/1000 gal. The treatment fluid may further comprise a plurality of proppant particles, and wherein the method further comprises forming a proppant pack in at least one fracture extending from the wellbore into the subterranean formation. The treatment fluid may further comprise a gel breaker. The hydrophobically-modified cellulose may be nonionic. The aqueous base fluid may be selected from the group consisting of freshwater, saltwater, brine, seawater, produced water, and combinations thereof. The treatment fluid may not comprise a crosslinking agent. The treatment fluid may not comprise a surfactant.

One or more illustrative examples incorporating the examples disclosed herein are presented herein. Not all features of a physical implementation are described or shown in this application for the sake of clarity. Therefore, the disclosed systems and methods are well adapted to attain the ends and advantages mentioned, as well as those that are inherent therein. The particular examples disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown other than as described in the claims below. It is therefore evident that the particular illustrative examples disclosed above may be altered, combined, or modified, and all such variations are considered within the scope of the present disclosure. The systems and methods illustratively disclosed herein may suitably be practiced in the absence of any element that is not specifically disclosed herein and/or any optional element disclosed herein.

Although the present disclosure and its advantages have been described in detail, it should be understood that various changes, substitutions and alterations can be made herein without departing from the spirit and scope of the disclosure as defined by the following claims.

What is claimed is:

1. A method of fracturing a subterranean formation comprising:
introducing a treatment fluid into a wellbore penetrating a subterranean formation at a pressure sufficient to create or extend at least one fracture in the subterranean formation, wherein the treatment fluid comprises an aqueous base fluid and a hydrophobically-modified cellulose.

2. The method of claim 1, wherein the hydrophobically-modified cellulose comprises a hydrophobic group selected from the group consisting of saturated aliphatics comprising between 8 and 30 carbons, saturated alcohols comprising between 1 and 30 carbons, and combinations thereof.

3. The method of claim 1, wherein the backbone of the hydrophobically-modified cellulose comprises a chain of about 1000 cellulose repeating units to about 2,000,000 cellulose repeating units.

4. The method of claim 1, wherein the hydrophobically-modified cellulose has a molecular weight between about 100,000 g/mol to about 2,000,000 g/mol.

5. The method of claim 1, wherein the hydrophobically-modified cellulose is present in the treatment fluid in a concentration of about 1 lbm/1000 gal to about 80 lbm/1000 gal.

6. The method of claim 1, wherein the treatment fluid further comprises a plurality of proppant particles, and wherein the method further comprises forming a proppant pack in at least one fracture extending from the wellbore into the subterranean formation.

7. The method of claim 1, wherein the treatment fluid further comprises a gel breaker.

8. The method of claim 1, wherein the hydrophobically-modified cellulose is nonionic.

9. The method of claim 1, wherein the aqueous base fluid is selected from the group consisting of freshwater, saltwater, brine, seawater, produced water, and combinations thereof

10. The method of claim 1, wherein the treatment fluid does not comprise a crosslinking agent.

11. The method of claim 1, wherein the treatment fluid does not comprise a surfactant.

12. A method of preparing a treatment fluid comprising:
adding solid hydrophobically-modified cellulose to an aqueous fluid comprising a total dissolved solids concentration of greater than 50,000 mg/L to produce hydrated hydrophobically-modified cellulose; and then
adding at least a portion of the hydrated hydrophobically-modified cellulose to an aqueous base fluid to produce the treatment fluid.

13. The method of claim 12, wherein the hydrophobically-modified cellulose comprises a hydrophobic group selected from the group consisting of saturated aliphatics comprising between 8 and 30 carbons, saturated alcohols comprising between 1 and 30 carbons, and combinations thereof.

14. The method of claim 12, wherein the backbone of the hydrophobically-modified cellulose comprises a chain of about 1000 cellulose repeating units to about 2,000,000 cellulose repeating units.

15. The method of claim 12, wherein the hydrophobically-modified cellulose has a molecular weight between about 100,000 g/mol to about 2,000,000 g/mol.

16. The method of claim 12, wherein the hydrophobically-modified cellulose is present in the treatment fluid in a concentration of about 1 lbm/1000 gal to about 80 lbm/1000 gal.

17. The method of claim 12, wherein the aqueous base fluid is selected from the group consisting of freshwater, saltwater, brine, seawater, produced water, and combinations thereof.

18. The method of claim 12, wherein the treatment fluid does not comprise a crosslinking agent.

19. A system for delivering a treatment fluid to a subterranean formation comprising:
a treatment fluid comprising:
a hydrophobically-modified cellulose, and
an aqueous base fluid;
a tubular penetrating the subterranean formation; and
a pump coupled to the tubular, wherein the pump is configured to pump the treatment fluid through the tubular and into the subterranean formation.

20. The system of claim 19, wherein the tubular extends from a wellhead and is fluidly coupled to a mixing tank upstream of the wellhead with a line.
